(19) United States
(12) Patent Application Publication
(10) Pub. No.: US 2003/0201128 A1
(43) Pub. Date: Oct. 30, 2003

(54) Snowmobile

(75) Inventors: Mr. Bruno Girouard, Bonsecours (CA); Mr. Berthold Fecteau, Richmond (CA)

(73) Assignee: Bombardier, Inc., Valcourt, Quebec (CA)

(21) Appl. No.: 09/472,134

(22) Filed: Dec. 23, 1999

Related U.S. Application Data
(60) Provisional application No. 60/167,614, filed on Nov. 26, 1999.

(30) Foreign Application Priority Data
Dec. 23, 1998 (CA) 2,256,944

(51) Int. Cl. B62M 27/02

(52) U.S. Cl. 180/190

(57) ABSTRACT

### Abstract of the Disclosure

A snowmobile is described having a frame and an engine disposed on the frame. A drive track is disposed below the frame and connected operatively to the engine for propulsion of the snowmobile. At least one ski is disposed on the frame. A seat is disposed rearwardly of the engine, suitable for a rider with a center of gravity, and a steering device is disposed above the engine and forward of the seat, the steering device being operatively connected to the at least one ski for steering the snowmobile. The snowmobile has a center of gravity positioned such that a distance between a vertical line passing through the center of gravity of the snowmobile and a vertical line passing through the center of gravity of the rider is within a predetermined range. Also, the distance between the steering position of the snowmobile and the seat position of the rider falls within a predetermined range. The rider is positioned on the snowmobile such that lines passing through the steering position, the seat position, and the footrest position form a triangle with angles α, β, and γ that have a specific relationship to one another. In addition, the steering position is disposed forward of the forward-most drive axle of the drive track. The footrests are positioned below the seat at a declining angle Δ to the horizontal. The axis of the steering column of the snowmobile forms an angle ε with vertical that falls within a predetermined range. A line passing through the steering position and the seat position forms an angle φ with the horizontal that falls within a predetermined range. A line passing through the center of gravity of the vehicle and the center of gravity of the rider forms an angle θ with the horizontal that falls within a specified range. Finally, the position of the rider is such that the head of the rider naturally falls within a laminar air flow region that is defines by the windshield of the snowmobile.

### Detailed Description of the Invention

### Cross Reference to Related Applications

This application claims the benefit of U.S. Provisional Patent Application No. 60/167,614, which was filed on November 26, 1999, which is incorporated herein by reference. This application also claims the benefit of priority to Canadian Patent Application No. 2,256,944, filed on December 23, 1998, which is incorporated herein by reference.

### Background of Invention

### Field of the Invention

The present invention concerns the overall design and construction of a snowmobile. More particularly, the present invention concerns a design for a snowmobile where, among other features, the steering control position, the seating position, and the position of the footrests are arranged in relation to one another so that the rider's center of gravity is closer to the center of gravity of the vehicle than on a conventional snowmobile. Moreover, the design for the snowmobile of the present invention improves the rider's control over the vehicle.

### Description of Related Art

Conventional snowmobiles share a common construction: they combine features and elements so that the rider sits in a generally upright position in a location toward the rear of the vehicle. When seated in this fashion, the rider sits a considerable distance behind the center of gravity of the vehicle (i.e., the center of gravity of the combination of the vehicle and the rider), which is located at or in proximity to the axis of the forward-most axle of the drive track.

When a snowmobile encounters a bump as it travels over the ground, the vehicle naturally tends to pivot about its center of gravity. Accordingly, the further the rider is positioned from the center of gravity of the vehicle, the more strongly the rider will feel each bump as he passes over it. This occurs because the vehicle acts as a lever that amplifies the magnitude of the forces transferred from bumps on the ground to the rider. In the case of the conventional snowmobile, because the rider is positioned toward the rear of the vehicle, the rider is acutely aware of this phenomenon.

Accordingly, while the positioning of the rider on the conventional snowmobile is entirely adequate for enjoying the sport of snowmobiling, a need has arisen for a snowmobile where the rider's position is improved to minimize the effect of the vehicle"s movement on the rider as it passes over uneven terrain.

### Summary of Invention

The present invention improves upon the conventional design by repositioning the rider on the vehicle and redesigning the layout of the vehicle to minimize the effect of the vehicle's movement on the rider as they pass over uneven terrain.

As would be understood by a person skilled in the art, a snowmobile has a center of gravity without the rider, and may have a different center of gravity with the rider. In the context of the present application it should be understood that the expression center of gravity of a snowmobile refers the center of gravity of a snowmobile with the rider, unless the contrary is indicated. Further, it should be understood that in the context of the present invention it is assumed that the vehicle is in running condition and is full of fuel.

The present invention provides a snowmobile with a frame and an engine disposed on the frame. A drive track is disposed below the frame and connected operatively to the engine for propulsion of the snowmobile. At least one ski is disposed on the frame and a seat is disposed rearwardly of the engine, suitable for a rider with a center of gravity. A steering device is disposed above the engine and forward of the seat and is operatively connected to the at least one ski for steering the snowmobile.

In one aspect, a distance a between a vertical line passing through the center of gravity of the snowmobile without the rider and a vertical line passing through the center of gravity of the snowmobile with the rider is preferably between about 0 and 14 cm. More preferably, distance a is between about 2 and 12 cm. Still more preferably, distance a is between about 4 and 10 cm. Still more preferably, distance a is between about 5 and 7 cm. Most preferably distance a is about 5 cm.

In another aspect, a distance z between a vertical line passing through the forward-most drive track axle (usually, but not exclusively the drive axle) and a vertical line passing through the center of gravity of the rider is preferably between about 15 and 65 cm. More preferably, distance z is between about 25 and 55 cm. Still more preferably, distance z is between about 35 and 55 cm. Still more preferably, distance z is between about 37 and 47 cm. Most preferably distance z is about 40 cm or about 45 cm.

In yet another aspect, a distance x between a vertical line passing through the center of gravity of the snowmobile with the rider and a vertical line passing through the center of gravity of the rider is preferably between about 0 and 50 cm. More preferably, distance x is between about 10 and 40 cm. Still more preferably, distance x is between about 22 and 32 cm. Most preferably, distance x is about 25 cm or about 30 cm.

In still yet another aspect, a distance y between a vertical line passing through the center of gravity of the snowmobile without the rider and a vertical line passing through the center of gravity of the rider is preferably between about 5 and 55 cm. More preferably, distance y is between about 15 and 45 cm. Still more preferably, distance y is between about 25 and 45 cm or between about 27 and 37 cm. Most preferably, distance y is about 30 or 35 cm.

Also in accordance with the teachings of the present invention, a snowmobile is provided that has a frame with an engine disposed thereon. A drive track is disposed below the frame and connected operatively to the engine for propulsion of the snowmobile. At least one ski is disposed on the frame. A seat is disposed rearwardly of the engine, suitable for a rider having a center of gravity, and a steering device is disposed forward of the seat. The steering device is operatively connected to the at least one ski for steering the snowmobile.

In one aspect, the snowmobile has a center of gravity positioned so that a line passing through the center of gravity of the snowmobile without the rider and the center of gravity of the snowmobile with the rider preferably forms an angle λ with horizontal that is between about 35 and 90°. More preferably, angle λ is between about 50 and 90°. Still more preferably, angle λ is between about 62 and 90°. Most preferably, angle λ is about 67°.

In another aspect, the snowmobile has a center of gravity positioned so that a line passing through the forward-most drive track axle and the center of gravity of the rider preferably forms an angle π with horizontal that is between about 41 and 75°. More preferably, angle πis between about 45 and 65°. Still more preferably, angle π is between about 50 and 60°. Most preferably, angle π is about 55°.

In still another aspect, the snowmobile has a center of gravity positioned so that a line passing through the center of gravity of the snowmobile without the rider and the center of gravity of the rider preferably forms an angle ω with horizontal that is between about 39 and 79°. More preferably, angle ω is between about 49 and 69°. Still more preferably, angle ω is between about 54 and 64°. Most preferably, angle ω is about 59°.

In yet another aspect, the snowmobile has a center of gravity positioned so that a line passing through the center of gravity of the snowmobile with the rider and the center of gravity of the rider preferably forms an angle θ with horizontal that is between about 35 and 84°. More preferably, angle θ is between about 45 and 75°. Still more preferably, angle θ is between about 55 and 70°. Most preferably, angle θ is about 57°.

According to further teachings of the present invention, a snowmobile is provided having a frame on which a seat is disposed that is suitable for a rider. A steering device is disposed on the frame forward of the seat. Right and left footrests are disposed below the seat on either side thereof, suitable for placement of a rider's feet thereon. The steering device defines a steering position, the seat defines a seat position, and the footrests define a footrest position. A line passing through the seat position and the steering position forms angle α with a line passing through the seat position and the footrest position. A line passing through the footrest position and the steering position forms angle β with the line passing through the footrest position and the seat position. Finally, the line passing through the footrest position and the steering position forms angle γ with the line passing through the steering position and the seat position. Preferably, angle α is between about 63 and 152°, angle β is between about 16 and 84°, and angle γ is between about 11 and 42°. More preferably, angle α is between about 67 and 112°, angle β is between about 41 and 72°, and angle γ is between about 22 and 45°. Still more preferably, angle α is between about 75 and 97°, angle β is between about 52 and 67°, and angle γ is between about 30 and 41°. Most preferably, angle α is about 83°, angle β is about 64°, and angle γ is about 33°.

According to additional teachings of the present invention, a snowmobile is provided with a frame and a seat disposed on the frame, suitable for a rider. A steering device is disposed on the frame forward of the seat. Right and left footrests are disposed below the seat on either side thereof, suitable for placement of the rider's feet thereon. The seat defines a seat position, the steering device defines a steering position, and the footrests define a footrest position. A line passing through the seat position and the steering position forms angle α with a line passing through the seat position and the footrest position, a line passing through the footrest position and the steering position forms angle β with the line passing through the footrest position and the seat position, the line passing through the footrest position and the steering position forms angle γ with the line passing through the steering position and the seat position, and angle α, angle β, and angle γ satisfy the relationship α≥β≥γ.

According to still further teachings of the present invention, a snowmobile is provided that has a frame and a seat disposed on the frame, suitable for a rider. A steering device is disposed on the frame forward of the seat. Right and left footrests are disposed below the seat on either side thereof, suitable for placement of the rider's feet thereon. The seat defines a seat position, the steering device defines a steering position, and the footrests define a footrest position. A line passing through the seat position and the steering position forms angle α with a line passing through the seat position and the footrest position. A line passing through the footrest position and the steering position forms angle β with the line passing through the footrest position and the seat position. The line passing through the footrest position and the steering position forms angle γ with the line passing through the steering position and the seat position. Angle α, angle β, and angle γ satisfy the relationship: angle α≈ 2.5γ.

A snowmobile is also provided with a frame and a seat disposed on the frame. A steering device is disposed on the frame forward of the seat. The seat defines a seat position and the steering device defines a steering position. A line passing through the steering position and the seat position forms an angle φ with horizontal that is between about 15 and 51°. More preferably, angle φ is between about 19 and 41°. Even more preferably, angle φ is between about 23 and 31°. Most preferably, angle φ is about 26°.

The present invention also provides for a snowmobile having a frame and at least one ski disposed on the frame. A steering shaft is operatively connected to the at least one ski for steering the snowmobile. The steering shaft is disposed over the engine at an angle εof less than about 45° from vertical. More preferably, angle ε is between about 25 and 40° from vertical. Even more preferably, angle ε is between about 30 and 35° from vertical. Most preferably, angle ε is about 33° from vertical.

According to still further teachings of the present invention, a snowmobile is provided with a frame and a seat disposed on the frame, suitable for a rider, the seat defining a location of a rider space associated with the seat. A steering shaft is disposed on the frame forward of the seat and a handlebar is mounted onto the steering shaft. The handlebar and steering shaft are rotatable about a central axis between first and second positions to define a handlebar space. The handlebar space does not intersect with the rider space.

According to further teachings of the present invention, a snowmobile is provided having a frame, a seat disposed on the frame, suitable for a rider, a steering device disposed forward of the seat, and a windshield disposed forward of the steering device, the windshield having a top. The steering device defines a steering position and the seat defines a seat position. A line between the steering position and the seat position forms an angle μ with a line between the seat position and the top of the windshield that lies between about 0 and 20°. More preferably, angle μ is between about 10 and 20°. Most preferably, angle μ is about 18°.

The teachings of the present invention also provide for a snowmobile having a frame and a seat disposed on the frame, suitable for a rider. A steering device is disposed forward of the seat. A windshield having a top is disposed forward of the seat. When in motion, the windshield defines a laminar flow region of moving air that extends upwardly and rearwardly from the top thereof. When seated in the seat and when grasping the steering device, the rider's head is positioned within the laminar flow region.

According to still further teachings of the present invention, a snowmobile is provided with a frame, a drive axle disposed on the frame, and a steering device disposed on the frame forward of the drive axle.

In addition, the present invention provides for a snowmobile with a frame, a seat disposed on the frame, suitable for a rider, and right and left footrests disposed below the seat on either side thereof, suitable for placement of the rider's feet thereon. A steering device is disposed forward of the footrests.

The present invention also provides for a snowmobile with a frame, a seat disposed on the frame, and a steering device disposed on the frame and forward of the seat. A distance b between vertical lines passing through the steering device and the seat is between about 40 and 90 cm. More preferably, distance b is between about 50 and 80 cm. Still more preferably, distance b is between about 60 and 80 cm. Most preferably, distance b is about 65 or 70 cm.

According to still further teachings of the present invention, a snowmobile is provided with a frame, a seat disposed on the frame, suitable for a rider, and right and left footrests disposed below the seat on either side thereof, suitable for placement of the rider's feet thereon. The footrests are disposed at an angle Δ with horizontal that is between about + 10 and - 20º. More preferably, angle Δ is between about + 10 and - 10º. Still more preferably, angle Δ is between about 0 and - 5º. Most preferably, angle Δ is about - 5º.

### Brief Description of Drawings

For a better understanding of the present invention as well as other objects and further features thereof, reference is made to the following description which is to be used in conjunction with the accompanying drawings, where:

FIG. 1 is a side view illustration of a conventional snowmobile, showing the traditional positioning of a rider thereon;

FIG. 2 is a perspective view of the snowmobile according to the teachings of the present invention, showing the positioning of a rider thereon;

FIG. 3 is a side view illustration of a conventional snowmobile and the snowmobile of the present invention superimposed on one another to illustrate the differences therebetween;

FIG. 4 is a top view representation of a snowmobile constructed according to the teachings of the present invention, showing the radius of travel of the steering device through a full range of motion;

FIG. 5 is a side view illustration of the positioning of the rider on the snowmobile of the present invention (which is not shown), showing the angular relationship between the steering position, the seat position, and the footrest position;

FIG. 6 is a side view illustration of the position of the rider on the snowmobile of the present invention as illustrated in FIG. 5, showing distances a, x, y, and z between various points;

FIG. 7 is a side view illustration of the position of the rider on the snowmobile of the present invention, showing angle λ formed by a line through the center of gravity of the vehicle with and without the rider and horizontal;

FIG. 8 is a side view illustration of the position of the rider on the snowmobile of the present invention, showing angle πformed by a line between the forward-most drive axle and the rider's center of gravity and horizontal;

FIG. 9 is a side view illustration of the position of the rider on the snowmobile of the present invention, showing angle ω formed between a line between the center of gravity of the vehicle without the rider and the rider's center of gravity and horizontal;

FIG. 10 is a side view illustration of the position of the rider on the snowmobile of the present invention, showing angle θ formed between a line between the center of gravity of the snowmobile of the present invention with a rider and the rider's center of gravity and horizontal;

FIG. 11 is a side view illustration of the position of the rider on the snowmobile of the present invention, showing angle φ formed by a line between the seat position and steering position and horizontal and also showing distance b between the steering position and seat position;

FIG. 12 is a side view illustration of the position of the rider on the snowmobile of the present invention, showing angle Δ of the footrests that is formed between a forward position of the sideboard and horizontal;

FIG. 13 is a side view illustration of the position of the rider on the snowmobile of the present invention, showing angle μformed between a line through the seat position and the steering position and a line through the seat position and the top of the windshield;

FIG. 14 is a side view illustration of the position of the rider on the snowmobile of the present invention, showing angle εof the steering shaft over the engine;

FIG. 15 is a side view illustration of the position of the rider on the snowmobile of the present invention, showing the zones of variance of the seating and steering positions;

FIG. 16 is a side view illustration of the position of the rider on the snowmobile of the present invention, showing the calculations of αₘᵢₙ and αₘₐₓ;

FIG. 17 is a side view illustration of the position of the rider on the snowmobile of the present invention, showing the calculations of βₘᵢₙ and βₘₐₓ;

FIG. 18 is a side view illustration of the position of the rider on the snowmobile of the present invention, showing the calculations of γₘᵢₙ and γₘₐₓ;

FIG. 19 illustrates a front elevational view of a standard rider; and

FIG. 20 illustrates a side elevational view of the standard rider illustrated in FIG. 19.

### Detailed Description

Throughout the description of the various embodiments of the present invention, reference will be made to various elements, the construction of which is readily known to those skilled in the art. Accordingly, an exhaustive description of each and every component is not provided, only a description of those elements required for an understanding of the present invention.

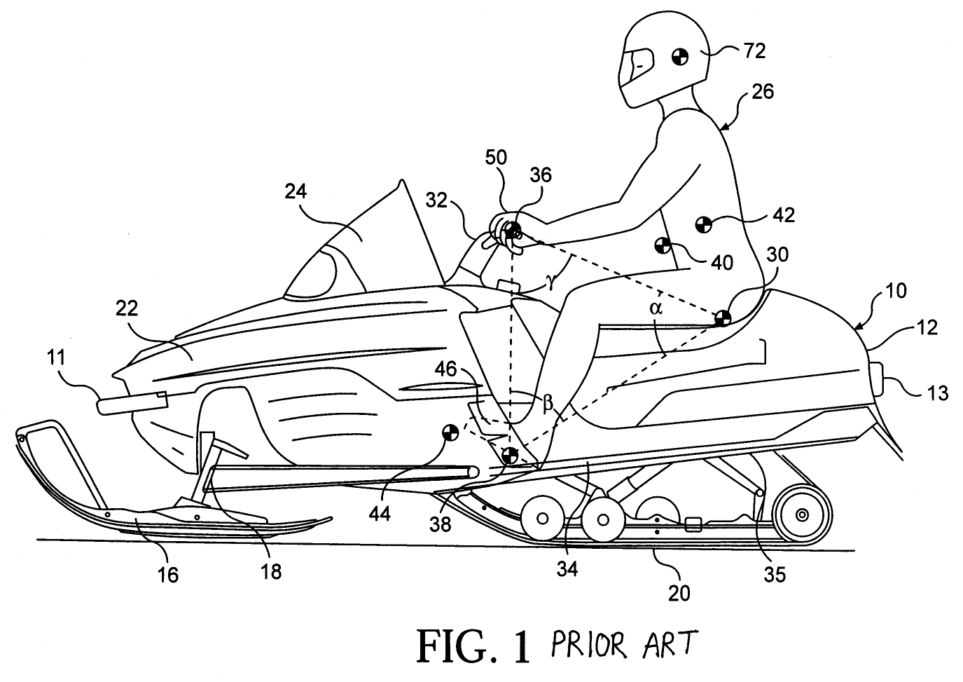

FIG. 1 illustrates a conventional snowmobile 10 (that sold by Bombardier Inc. of Montreal, Canada, under the trademark SKI-DOO, model MXZ, model year 1999), which has a forward end 11 and a rearward end 13 (that are defined consistently with the travel direction of the vehicle). Conventional snowmobile 10 includes a body 12 (i.e., the exterior upper portions) and a frame 14. While not shown in FIG. 1, an engine is carried by frame 14 at its forward end. In addition, two skis 16 are attached to the forward end of frame 14 through a suspension system 18. A drive track 20 is disposed under frame 14 and is connected operatively to the engine for propulsion of the vehicle.

At the front of frame 14, snowmobile 10 includes fairings 22 that enclose the engine to protect it and to provide a external shell that can be decorated so that the snowmobile is aesthetically pleasing. Typically the fairings 22 comprise a hood and a bottom pad (neither of which have been individually identified in the Figures). A windshield 24 may be connected to fairings 22 near the forward end 11 of snowmobile 10. Windshield 24 acts as a windscreen to lessen the force of the air on rider 26 when snowmobile 10 is moving.

A seat 28 extends from rearward end 13 of snowmobile 10 to the fairings 22. A steering device 32, such as a handlebar, is positioned forward of rider 26 and behind the engine. Two footrests 34 are positioned on either side of seat 28 to accommodate the rider's feet 46.

When seated, the average rider 26 will be positioned so that his hands grasp steering device 32 at steering position 36. Moreover, rider 26 will be seated so that the center of his torso 42 is above seat position 30. When seated in this manner, the rider's feet 46 naturally will be placed at footrest position 38. Positioned in this manner, the rider's center of gravity 40 will be located just forward of the rider's stomach, offset from the center of the rider's torso 42. (The rider's center of gravity 40 is offset forwardly from the center of the rider's torso 42 because the rider's arm and legs are disposed forward of the rider's torso 42 when rider 26 is in the driving position.)

For conventional snowmobile 10, the rider's center of gravity 40 is behind the center of gravity of the snowmobile 44 (i.e., the center of gravity of the snowmobile with the rider). The center of gravity of the snowmobile 44 is located on or near the forward-most axle of drive track 20. (While the forward-most axle of drive track 20 is not shown, those skilled in the art will readily appreciate that it is located at or near the position labeled as the center of gravity of the vehicle 44.) The location of the center of gravity of the vehicle without the driver 44' is forward of the center of gravity of the vehicle with the driver 44. It is also lower than the center of gravity of the vehicle with the driver 44. In addition, footrests 34 are inclined upwardly from the horizontal so that the rider's feet 46 are in a comfortable position when rider 26 is seated on snowmobile 10.

For conventional snowmobile 10, the positioning of these various components and elements creates a situation where rider 26 is seated in a relatively upright position toward the rear of the vehicle. As shown in FIG. 1, with the rider's feet 46 positioned on footrests 34, the rider's knees 48 are positioned close to the steering position 36 where the rider's hands 50 are located. The placement of seat 28 is such that the seat position 30 is even with or slightly below the rider's knees 48. These elements, coupled with the placement of steering position 36 behind foot position 38, creates a situation where rider 26 sits inclined slightly forward, as indicated in FIG. 1.

The positioning of rider 26 shown in FIG. 1 is considered standard. Before the present invention, there was no motivation to adjust the position of rider 26 because the standard position does not hinder operation of the vehicle nor does it create an unsafe riding condition for rider 26. Moreover, the conventional positioning of rider 26 on snowmobile 10 does not prevent rider 26 from enjoying the sport of snowmobiling.

Despite this, the inventors of the present invention realized that it is possible to improve upon the construction of a snowmobile to alter the positioning of the rider to improve considerably the handling and ride of the vehicle.

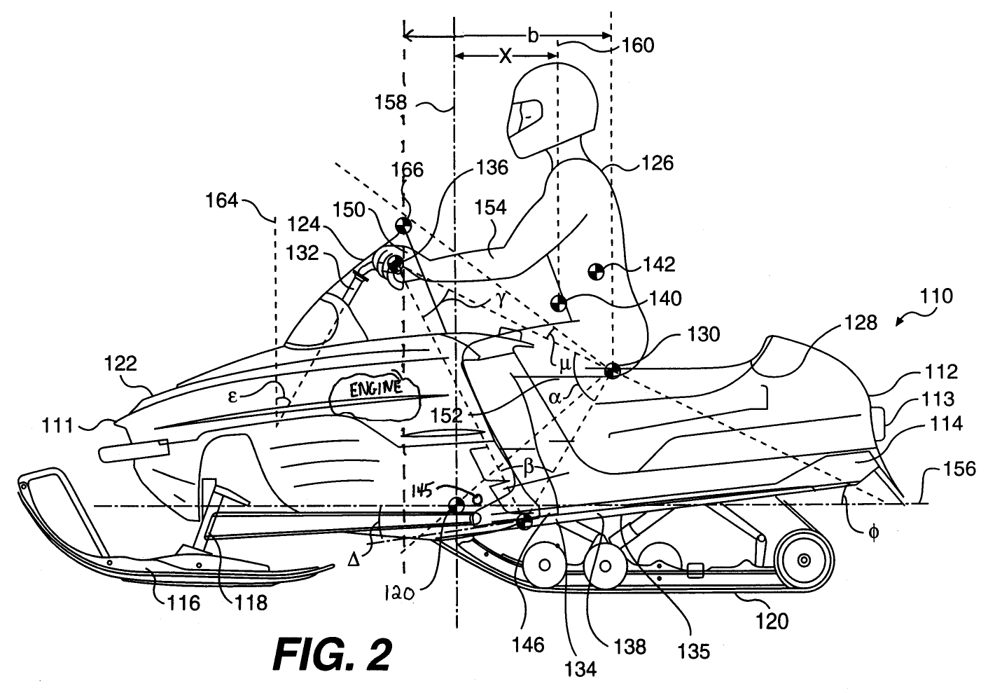

FIG. 2 illustrates snowmobile 110, which is made according to the teachings of the present invention.

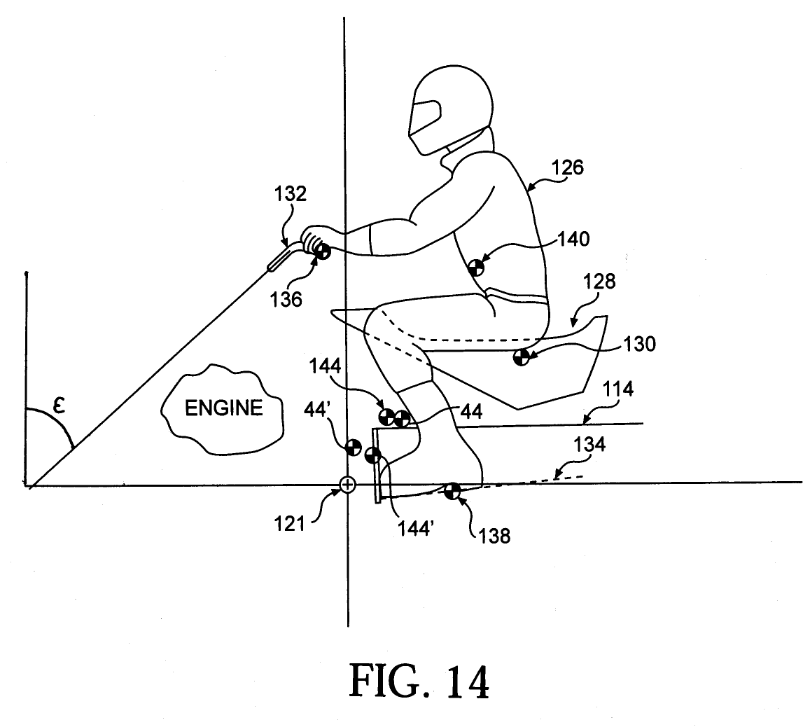

Like snowmobile 10, snowmobile 110 has a body 112 and a frame 114. Two skis 116 are positioned at the front of frame 114 so that snowmobile 110 may be steered over the snow. Skis 116 are connected to frame 114 through a suspension system 118 attached to frame 114 at its forward end. An engine (the position of which is shown generally in FIG. 14) is also disposed at the forward end of snowmobile 110 and is covered by fairings 122 that protect the engine and provide snowmobile 110 with an aesthetically pleasing appearance. A windshield 124 may extend upwardly from fairings 122 to act as a windscreen for rider 126.

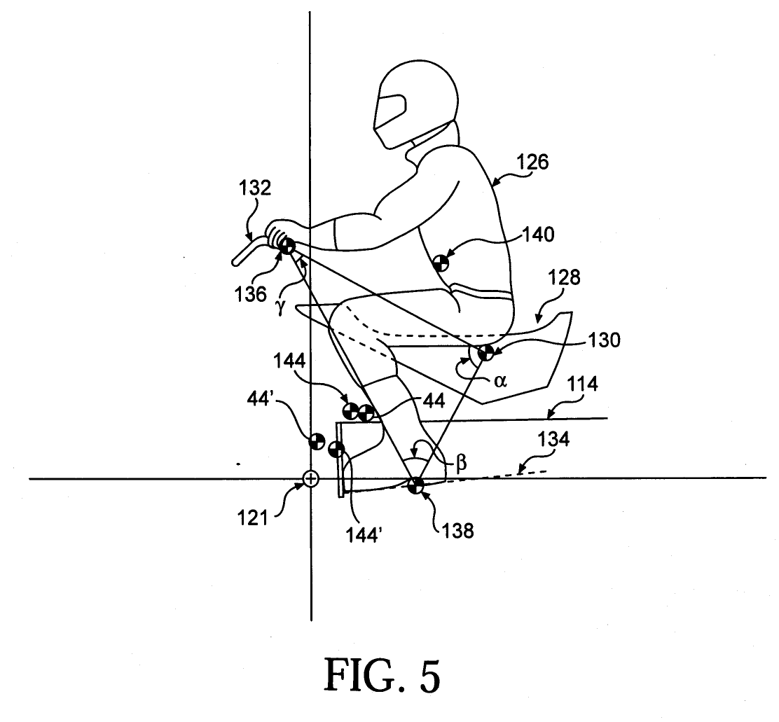

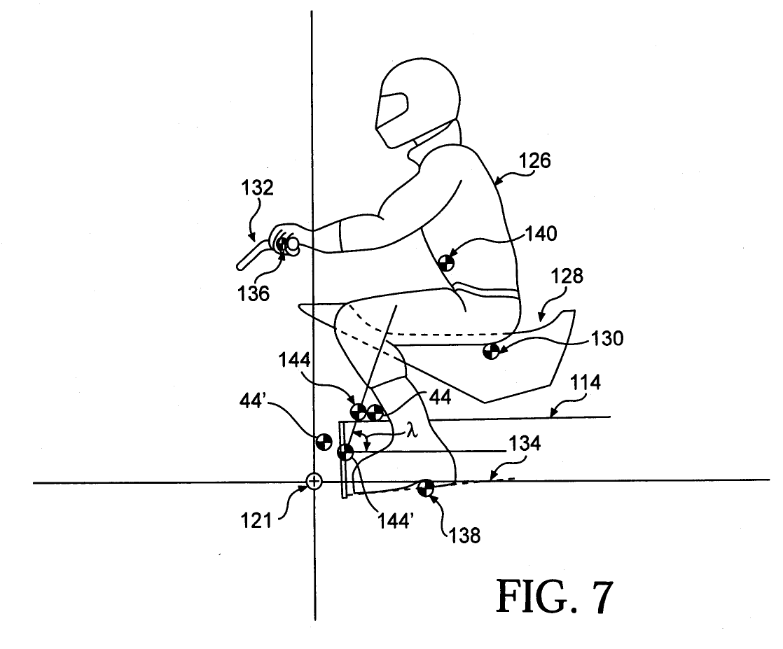

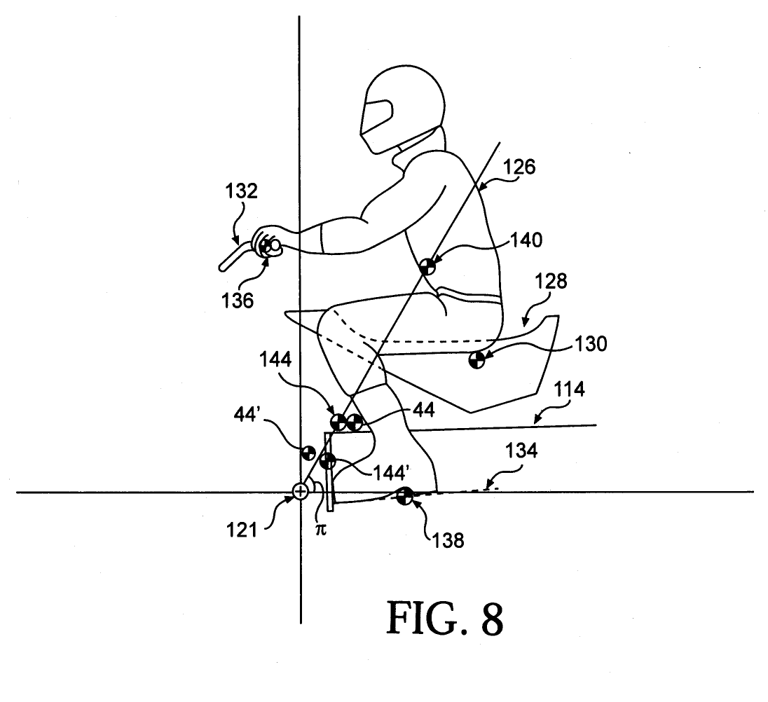

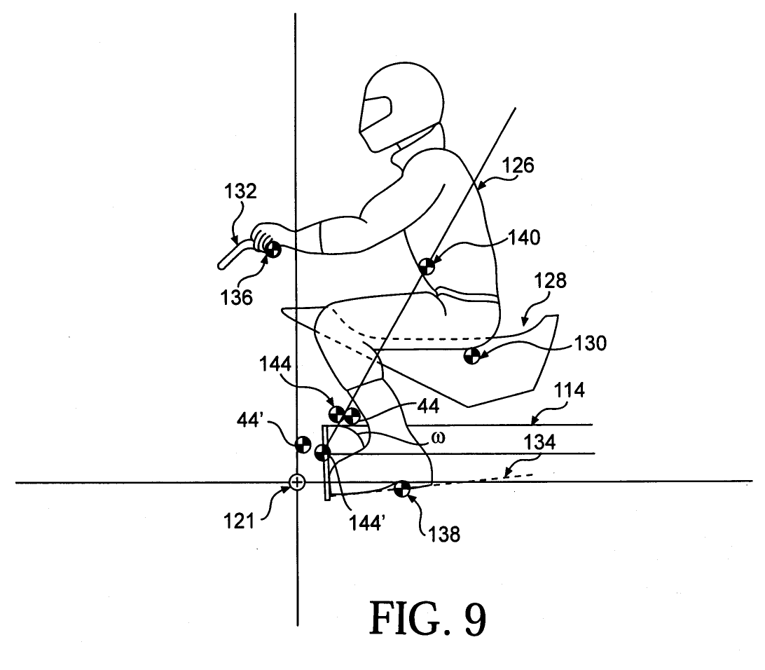

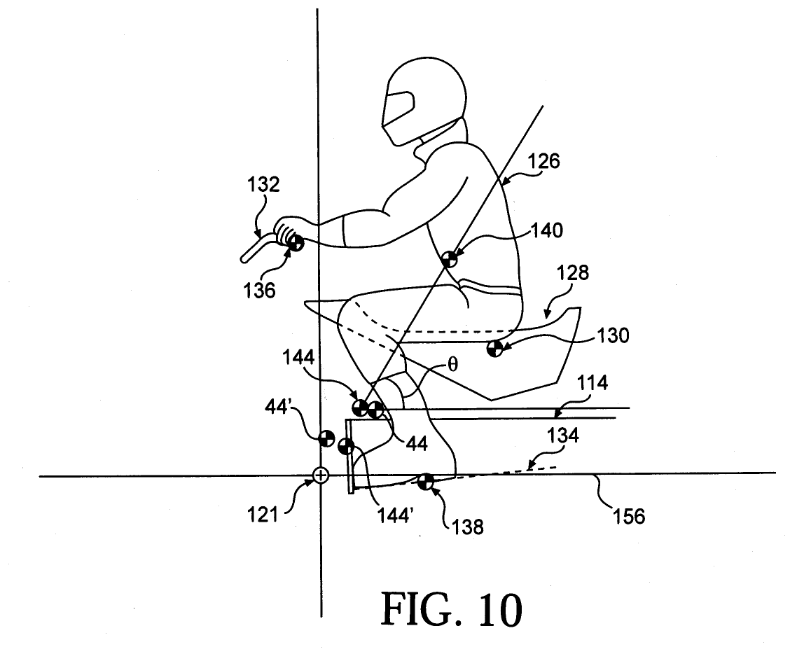

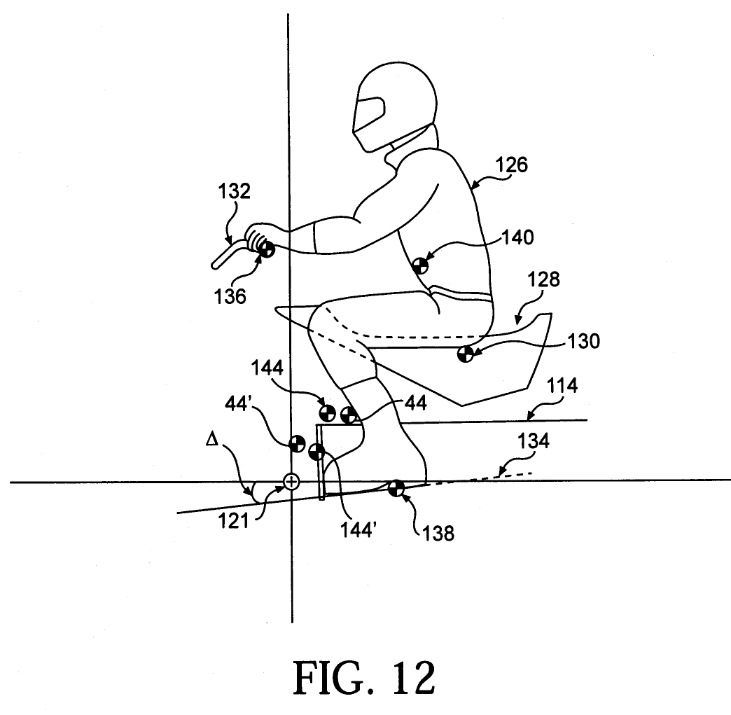

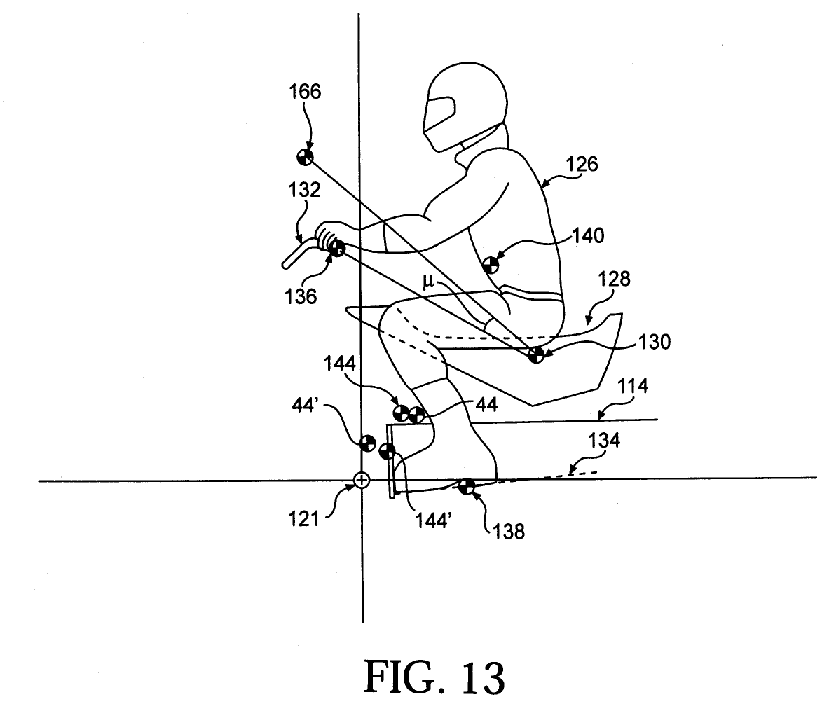

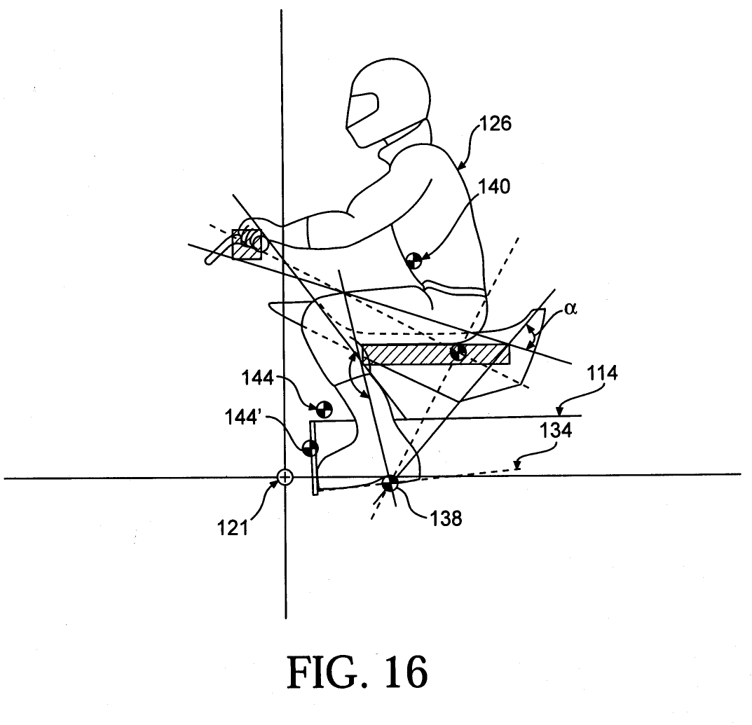

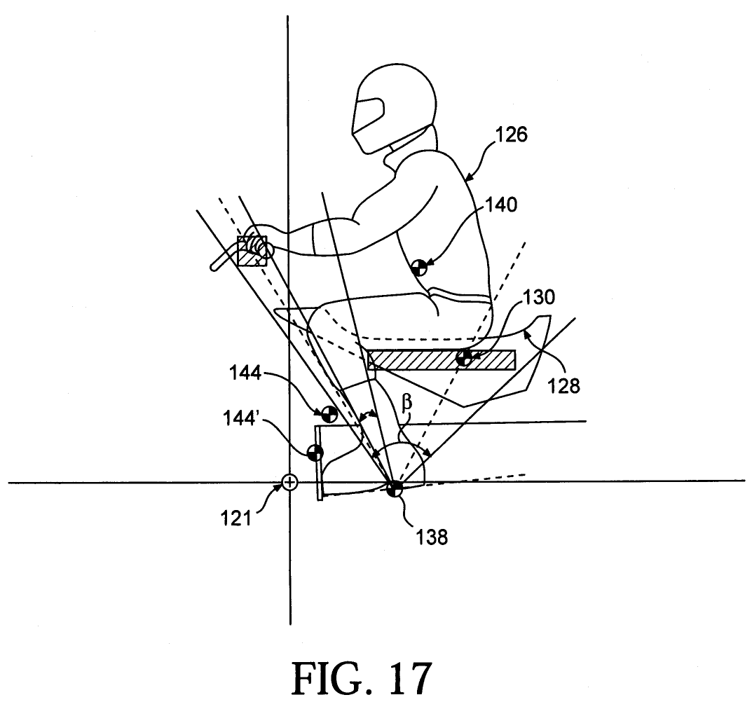

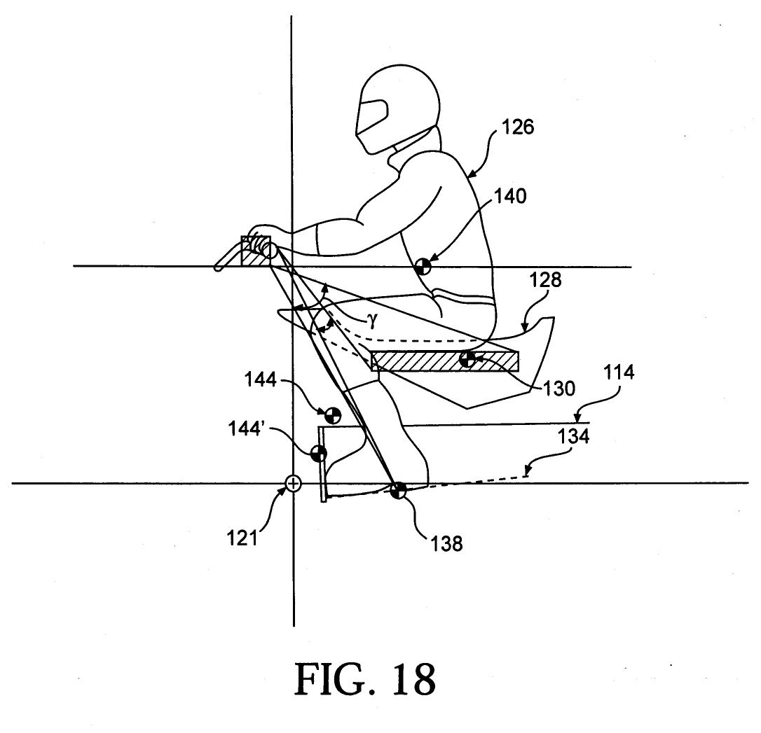

A drive track 120, which is operatively connected to the engine, is positioned below frame 114. Drive track 120 is a continuous belt that runs around a number of axles including a forward-most axle 121 that is obscured by fairings 122 in FIG. 2 (but is illustrated in FIGS. 5-18). Forward-most axle 121 of snowmobile 110 is at or near the center of gravity 144 of snowmobile 110 with the rider, as would be understood by those skilled in the art. Further details in this respect are provided in connection with the discussion that accompanies FIGS. 5-18. FIGS. 5-18 show that portion of the frame 114 which is commonly referred to in the snowmobile art as a tunnel.

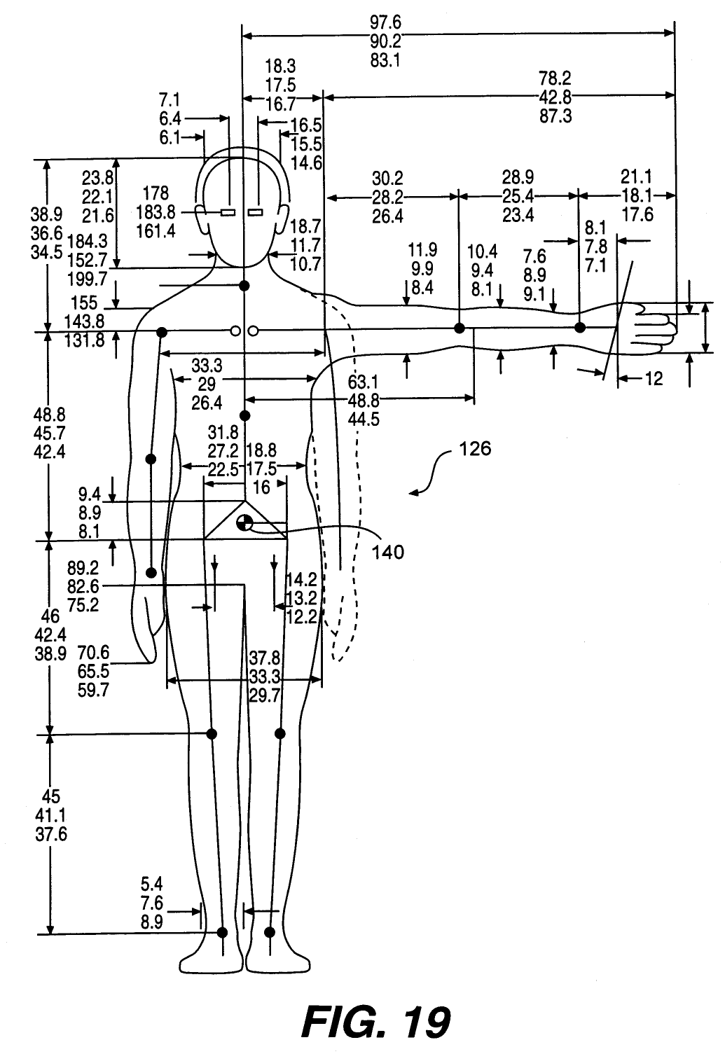

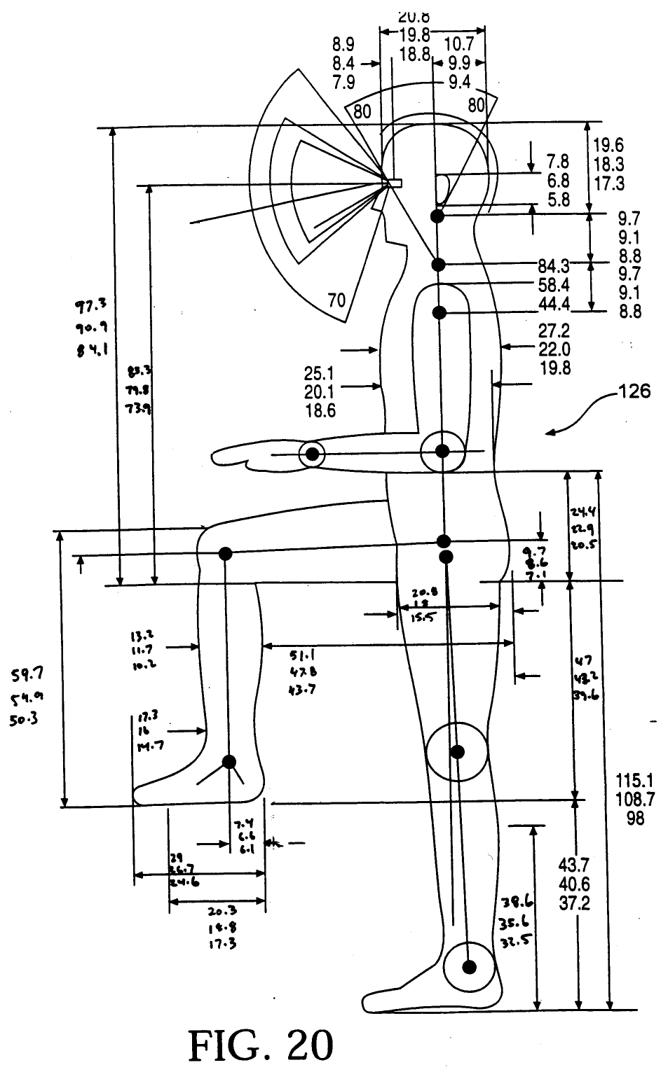

When rider 126 is on snowmobile 110, the rider will be positioned on seat 128 so that he occupies seat position 130. Seat position 130 is the point at which the weight of the rider 126 is exerted on the seat 128. This point may vary from rider to rider, given changes in height and weight from one rider to another. In cases of difficulty, it may be determined by taking a 50-percentile United States human male (having a weight of 174.8 pounds and dimensions as shown in FIGS 19 and 20), placing him on the snowmobile in the position shown in the Figures (i.e., that approximate position of a rider a few seconds after starting the vehicle, heading straight ahead on a flat terrain), and drawing a line from his shoulder through his hip. (For purposes of this discussion, a standard person is illustrated in FIGS. 19 and 20.) The intersection of that line with the seat may be considered to be the seat position 130. It will also be understood that seat 128 will be covered with an amount of foam or similar padding-type material, and that the amount of that foam will vary from seat to seat. When the rider 126 sits upon the seat 128, his weight will cause the foam to compress and he will sink into the seat 128. Preferably, the seating position 130 is determined after this compression has occurred.

Steering device 132 is positioned at the forward end of snowmobile 110 and above the engine so that steering position 136 is forward of and above the center of gravity 144 of snowmobile 110. (For purposes of this discussion, the forward direction is toward forward end 111 of snowmobile 110 while the rearward direction is toward rearward end 113 of the vehicle.) As is the case with the seating position 130, the steering position 136 may vary depending on the size and shape of the hands of the rider 126. In cases of difficulty, the steering position 136 may be determined by placing the hands of the same 50-percentile rider described above, placing it on the steering device 132 in normal operating position. The steering position 136 will be the intersection of the center of the palm of the hands of the rider 126 and the steering device 132.

It should be noted that steering device 132 is shown in the various figures as a handlebar but should not be limited to just this particular construction. It would be understood by those skilled in the art that any suitable steering device may be used for snowmobile 110. For example, steering device 132 could be a steering wheel or a yoke of the type used in aircraft. Moreover, the positioning of steering device 132 above the engine also should not be considered to be limited to the position illustrated in FIG. 2. As would be understood by those skilled in the art, depending on the particular arrangement of elements for the snowmobile, it is possible that steering device 132 could be positioned higher or lower than shown in FIG. 2 without departing from the scope and spirit of the present invention.

The rider's feet 146 rest on footrests 134 in footrest position 138 just behind the center of gravity of the snowmobile 110. The footrest position 138 is in the location of the arch of the foot of the rider 126 when his feet are placed in normal operating position on the vehicle. Under normal operating conditions, the rider's feet 146 will rest on a forward portion of the sideboards. Preferably, toeholds 145 are disposed above these forward portion and permit the rider to releasably secure himself to the vehicle.

As shown in FIG. 2 and more clearly in FIG. 5, rider 126 is positioned on snowmobile 110 so that a line passing through seat position 130 and steering position 136 forms an angle α with a line passing through seat position 130 and footrest position 138. In addition, a line passing through footrest position 138 and steering position 136 forms an angle β with a line passing through footrest position 138 and seat position 130. Finally, a line passing through footrest position 138 and steering position 136 forms an angle γ with a line passing through steering position 136 and seat position 130. In other words, steering position 136, footrest position 138 and seat position 130 form a triangle with angles α, β, and γ that each fall within certain preferred ranges. For example, it is preferred that angle α lie within a range of between about 63 and 152°, that angle β lie within a range of between about 16 and 84°, and that γ lie within a range of between about 11 and 42°. It is more preferred that angle α lie within a range of between about 67 and 112°, that angle β lie within a range of between about 41 and 72°, and that γ lie within a range of between about 22 and 45°. It is even more preferred that angle α lie within a range of between about 75 and 92°, that angle β lie within a range of between about 52 and 67°, and that γ lie within a range of between about 30 and 41°. Finally, it is most preferred that angle α be about 83°, that angle β be about 64°, and that γ be about 33°. In addition, it is preferred that angles α, β, and γ be selected so that α≥β≥γ. Moreover, it is preferred that the angles be selected to satisfy the following equation: α≈ 2.5γ.

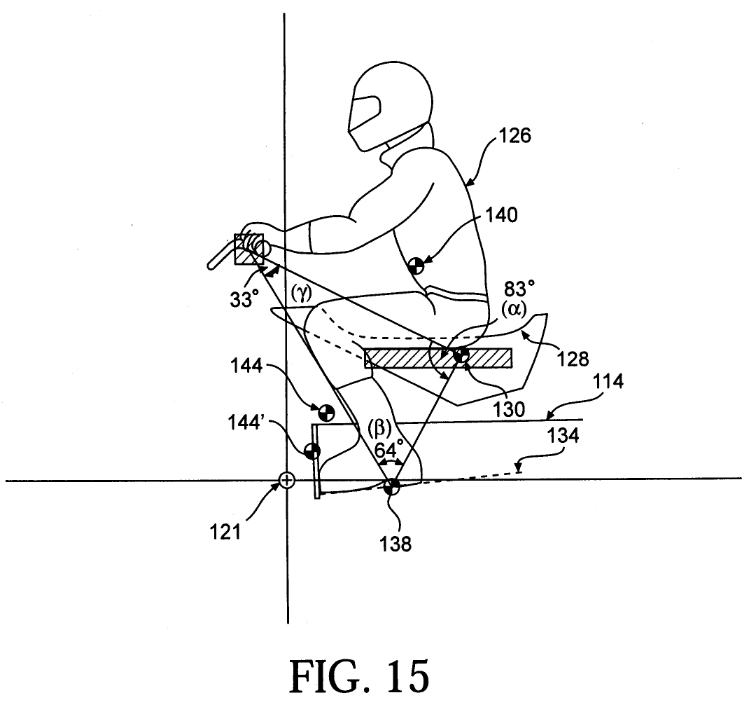

FIGS. 15-18 illustrate the ranges within which seat position 130 and steering position 136 may be varied while remaining within the scope of the present invention. The cross-hatched regions indicate the range within which steering position 136 and seat position 130 may fall depending upon the design of snowmobile 110 and the size and shape of rider 126.

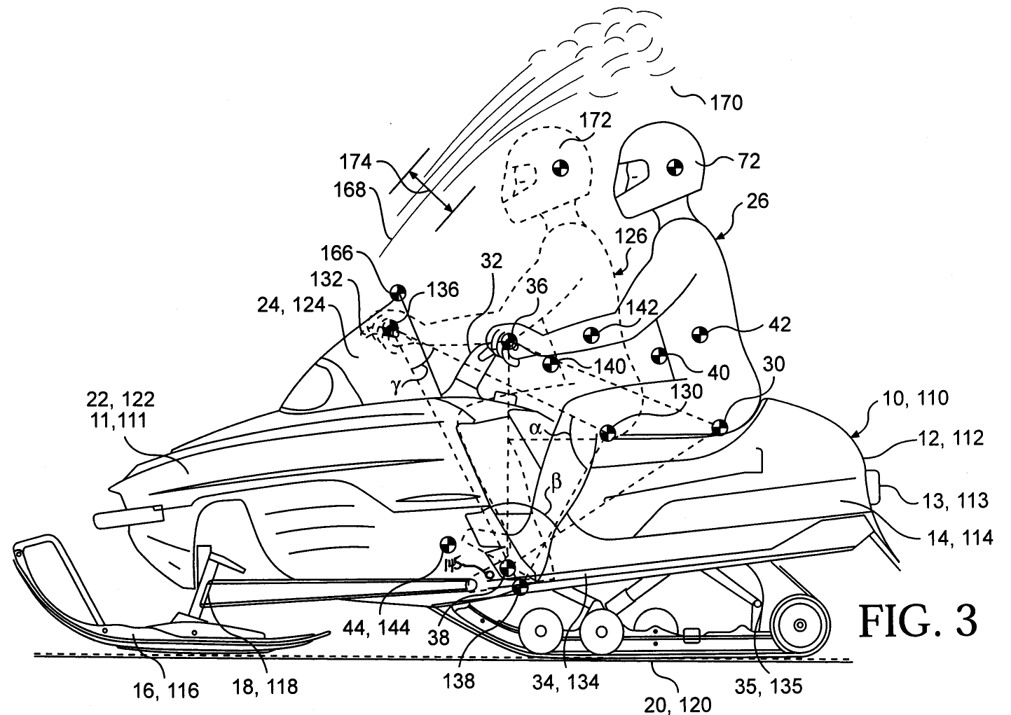

When angles α, β, and γ satisfy any of the relationships set forth above, and preferably when steering position 136 is positioned forward of a vertical line passing through the vehicle's center of gravity 144, the rider's center of gravity 140 is positioned much closer to the center of gravity of the vehicle 144 than for conventional snowmobile 10 (as illustrated in FIG. 3). In addition, when rider 126 is positioned as illustrated in FIG. 2, the rider's feet 146 are more in line with his torso 142 and his center of gravity 140. This position has a number of advantages, as described in greater detail below.

When rider 26 is sitting on conventional snowmobile 10, if he sees a large bump ahead, it is natural for rider 26 to try to raise himself off of seat 28 to minimize the impact of the bump as he passes over it. However, because of his positioning on conventional snowmobile 10, in order for rider 26 to stand up, he must pull on steering device 32 using his upper body. The positioning of the rider's feet 46 forward of the rider's center of gravity 40 and at an incline on footrests 34 makes it difficult for rider 26 to stand on snowmobile 10 using only the strength of his legs. Moreover, even after rider 26 lifts himself from seat 28, his center of gravity 40 remains sufficiently rearward of the center of gravity of the vehicle 44 that he will perceive the large bump.

In snowmobile 110 of the present invention, however, a wholly different result is achieved. First, steering position 136 is displaced forward of the center of gravity of the vehicle 144. This position pulls rider 126 forward of the conventional position. By moving seat position 130 closer to the center of gravity of the vehicle 144 than the conventional example, and by redesigning footrests 134 so that they are kept at a decline, rider 126 is positioned so that, if a large bump is seen in the path ahead, rider 126 can easily raise himself from the seat using primarily the strength of only his legs 152. Since rider 126 is disposed closer to the center of gravity of the vehicle 144, when snowmobile 110 passes over a large bump, the effect of the bump is not transferred to rider 126 with the same magnitude as the force transferred to rider 26 on conventional snowmobile 10.

In addition, because rider 126 can raise himself from seat 128 using his legs 152 and not his arms 154, rider 126 can maintain greater control over snowmobile 110 as he passes over the obstacle than rider 26 on conventional snowmobile 10. If rider 26 (of conventional snowmobile 10) tries to pull himself from seat 28 as he passes over a large bump or obstacle, he sacrifices some of this strength pulling himself up from seat 28 and, therefore, may be less able to steer and control the vehicle as he passes over the obstacle.

To facilitate the rider's ability to raise himself off of seat 128 using his legs 152, footrests 134 are not inclined as with snowmobile 10. Instead, footrests 134 are part of the forward portion of the sideboards 135 that laterally extend from the frame below the seat on either side thereof. As a result, footrests 134 are at angle Δ with respect to the horizontal. Preferably, angle Δ is between about +10 and -20°. More preferably, angle Δ lies between about +10 and -10°. Even more preferably, angle Δ lies between about 0 and -5°. Most preferably, angle Δ is about -5°.

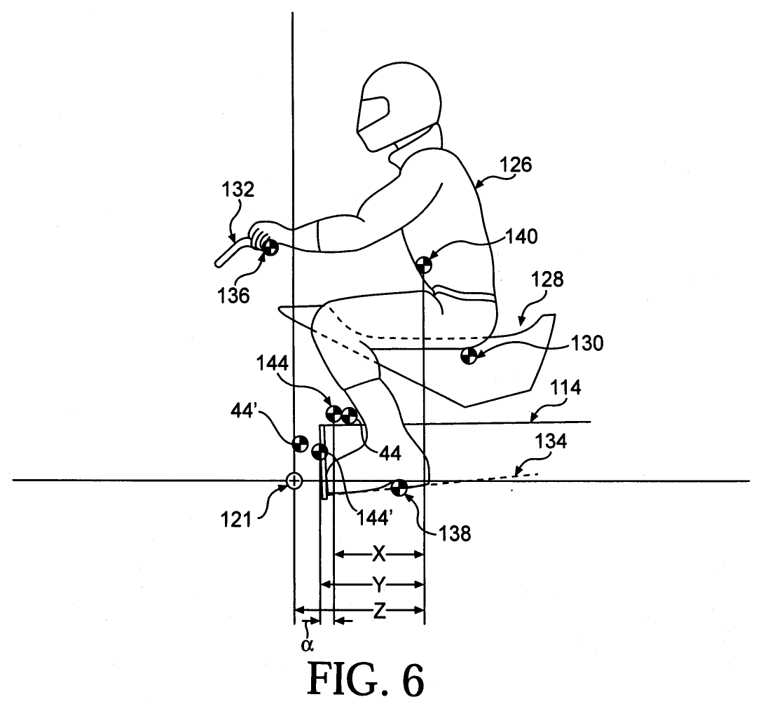

As mentioned, one aspect of the present invention that improves upon the conventional snowmobile 10 is the fact that the rider's center of gravity 140 is closer to the center of gravity of the vehicle 144 than in the conventional example. This positioning helps to minimize the effect of bumps and terrain on rider 126. Referring to FIGS. 2 and 6, it is preferred that a distance x, measured as the distance between a vertical line 158 passing through the center of gravity of the vehicle 144 and a vertical line 160 passing through the center of gravity of the rider 140, be between about 0 and 50 cm. It is more preferred that distance x be between about 10 and 40 cm. In still a more preferred example, distance x is between about 22 and 32 cm. In the most preferred example, distance x is about 25 or 30 cm.

Also, a distance a between a vertical line passing through the center of gravity of the snowmobile without the rider 144' and a vertical line passing through the center of gravity of the snowmobile with the rider 144 is preferably between about 0 and 14 cm. More preferably, distance a is between about 2 and 12 cm. Still more preferably, distance a is between about 4 and 10 cm. Still more preferably, distance a is between about 5 and 7 cm. Most preferably, distance a is about 5 cm.

Similarly, a distance z between a vertical line passing through the forward-most drive track axle 121 (usually, but not exclusively the drive axle) and a vertical line passing through the center of gravity of the rider 140 is preferably between about 15 and 65 cm. More preferably, distance z is between about 25 and 55 cm. Still more preferably, distance z is between about 35 and 55 cm. Still more preferably, distance z is between about 37 and 47 cm. Most preferably, distance z is about 40 cm or about 45 cm.

In addition, a distance y between a vertical line passing through the center of gravity of the snowmobile without the rider 144' and a vertical line passing through the center of gravity of the rider 140 is preferably between about 5 and 55 cm. More preferably, distance y is between about 15 and 45 cm. Still more preferably, distance y is between about 25 and 45 cm or between about 27 and 37 cm. Most preferably, distance y is about 30 or 35 cm.

Similarly, when rider 126 is positioned on snowmobile 110 so that his center of gravity 140 is closer to the center of gravity of the vehicle 144 than the conventional example, a line passing through the center of gravity of the vehicle 144 and the center of gravity of the rider 140 forms an angle θ with horizontal 156 that preferably falls within a range between about 35 and 84°. More preferably, angle θ lies between 45 and 75°. Still more preferably, angle θ lies within a range between about 55 and 70°. Finally, angle θ is about 57°.

In this regard, snowmobile 110 has a center of gravity positioned so that a line passing through the forward-most drive track axle 121 and the center of gravity of the rider 140 preferably forms an angle πwith horizontal that is between about 41 and 75°. More preferably, angle πis between about 45 and 65°. Still more preferably, angle πis between about 50 and 60°. Most preferably, angle πis about 55°.

Snowmobile 110 has a center of gravity positioned so that a line passing through the center of gravity of the snowmobile without the rider 144" and the center of gravity of the snowmobile with the rider 144 preferably forms an angle λwith horizontal that is between about 35 and 90°. More preferably, angle λis between about 50 and 90°. Still more preferably, angle λis between about 62 and 90°. Most preferably, angle λis about 67°.

Snowmobile 110 has a center of gravity positioned so that a line passing through the center of gravity of the snowmobile without the rider 144" and the center of gravity of the rider 140 preferably forms an angle ω with horizontal that is between about 39 and 79°. More preferably, angle ω is between about 49 and 69°. Still more preferably, angle ωis between about 54 and 64°. Most preferably, angle ωis about 59°.

In addition, when rider 126 is positioned on snowmobile 110 so that his center of gravity 140 is closer to the center of gravity of the vehicle 144 than in conventional snowmobile 10, a distance b between a vertical line passing through steering position 136 and a vertical line passing through seat position 130 is between about 40 and 90 cm. Preferably, distance b is between about 60 and 80 cm. Most preferably, distance b (in FIG. 2) is either 65 or 70 cm.

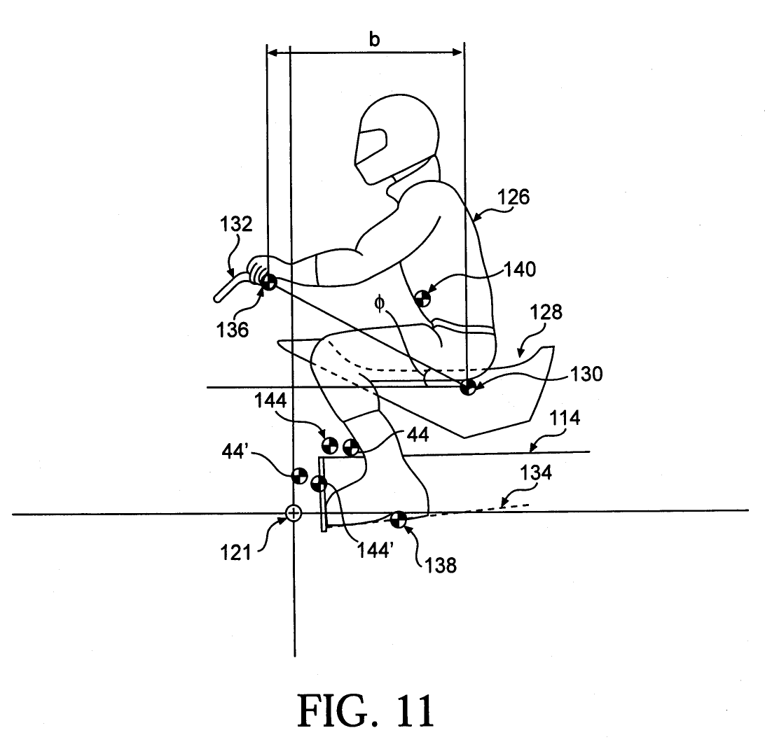

Furthermore, as shown in FIG. 11, with the steering position 136 and seat position 130 located so that the center of gravity of the rider 140 is closer to the center of gravity of the vehicle 144 than the conventional example, a line passing through steering position 136 and seat position 130 forms an angle φ with horizontal 156 that lies in a range between about 15 and 51°. More preferably, angle φ lies in a range between about 19 and 41°. Even more preferably, angle φ lies in a range between about 23 and 31°. Most preferably, angle φ is about 26°.

To improve the steerability of snowmobile 110, the inventors also altered the positioning of the axis of the steering shaft 162 so that it is more steeply sloped than the steering shaft in prior art snowmobiles having a steering shaft over the engine. With a steeper slope to the axis of the steering shaft 162, the turning force applied by rider 126 is more directly applied to steer the vehicle. According to the present invention, and as illustrated in FIGS. 2 and 14, the axis of the steering shaft 162 forms an angle ε with vertical 164 that is less than 45°. More preferably, angle ε lies between about 25 and 40°. Even more preferably, angle ε lies between about 30 and 35°. Most preferably, angle ε is about 33°. The angular position of the steering shaft 162 is also preferred because it facilitates placement of steering position 136 in a position forward of that for conventional snowmobile 10.

Positioning rider 126 on snowmobile 110 in the manner described has still further advantages. Windshield 124 has a top 166. When snowmobile 110 is moving, top 166 of windshield 166 defines a point from which the air travels along a travel path 168. The air along air travel path will have laminar flow characteristics until it reaches a turbulent flow region 170. When rider 126 is positioned on snowmobile 110 as described above, the rider's head 172 falls within the laminar flow region 174. As a result, rider 126 enjoys a more comfortable ride because the air has a less adverse effect on his head 172 in terms of temperature, noise, etc.

Those skilled in the art will readily recognize that the positioning of the rider's head 172 on snowmobile 110 is very different than that for conventional snowmobile 10. As illustrated in FIG. 3, head 72 of rider 26 falls into the turbulent flow region 170. Accordingly, rider 26 experiences a poorer quality ride than rider 126.

The positioning of rider 126 on snowmobile 110 in the manner taught by the present invention offers still further advantages. As illustrated, the view that rider 126 has of the ground in front of him is much improved over the view of the ground in front of rider 26 on conventional snowmobile 26. This is true because rider 126 has less of the snowmobile fairings 122 and windshield 124 in front of him than rider 26 does. As a result, rider 126 is better able to react to obstacles in his immediate path than rider 26.

The height of the windshield 124, the location of seat position 130 and the location of steering position 136 define a relationship that facilitates construction of a snowmobile 110 where the view of the rider is improved. Specifically, a line between the top 166 of windshield 124 and seat position 130 forms an angle μ with a line between steering position 136 and seat position 130 that lies between about 0 and 20°. Preferably, angle μ lies between about 10 and 20°. Most preferably, angle μ is about 18°.

The design of snowmobile 110 offers still further advantages. For example, as illustrated in FIG. 1, the rider's knees 48 are positioned very close to steering position 36. As a result, when rider 26 steers snowmobile 10, it is not uncommon for rider 26 to hits his knees 48 with steering device 32. This presents a minor design difficulty that the present invention solves.

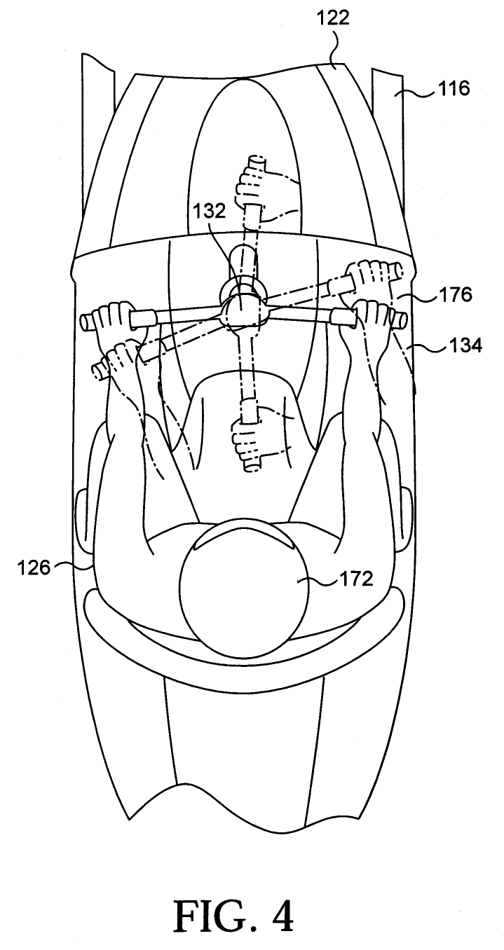

As shown in FIG. 4, when rider 126 turns steering device 132 to its maximum positions, the handlebars sweep out a handlebar space 176. Because steering device 132 is positioned forward of the center of gravity of the vehicle 144, handlebar space 176 cannot intersect with the space occupied by rider 126. In other words, rider 126 will not normally hit his knees 148 with steering device 132 while riding snowmobile 110.

Snowmobile 110 of the present invention also differs from conventional snowmobile 10 in that the steering device 132 is disposed forward of the axis of the forward-most drive axle, which corresponds closely to the center of gravity of the vehicle 144. Steering device 132 is also positioned forward of footrest position 138, which also differs from conventional snowmobile 10. With steering position 136 disposed forward of both the center of gravity of the vehicle 144 and forward of the footrest position 138, the center of gravity of the rider 140 is positioned much closer to the center of gravity of the vehicle 144 than in conventional snowmobile 10.

The present invention offers still further advantages over the design of conventional snowmobile 10. Since rider 126 is positioned closer to the center of gravity of the vehicle 144, the ride for a second rider on the same vehicle is also improved because the second occupant is also disposed closer to the center of gravity of the vehicle. FIG. 3 is illustrative.

Rider 26 (who is shown astride conventional snowmobile 10) is essentially in the second passenger seat for snowmobile 110. Since rider 126 has been moved forward, the second rider is subject to the kind of forces that he would be subjected to if he were driving a conventional snowmobile 10. In other words, the second rider is no worse off than he would be if he were passenger 26 on conventional snowmobile 10. Indeed the second rider's situation is quite improved, and may approach that of a rider 26 on a conventional snowmobile 10.

In addition, since second rider experiences a similar ride experience to what rider 26 experiences on conventional snowmobile, it is possible that a third rider could be added to snowmobile 110 behind the second rider. The third rider, then, would experience the forces similar to those that a second rider would normally experience on conventional snowmobile 10.

While the invention has been described with reference to several preferred embodiments, it will be understood by those skilled in the art that various changes may be made and equivalents may be substituted for elements thereof without departing from the spirit and scope of the present invention. In addition, many modifications may be made to adapt a particular situation, component, or material to the teachings of the present invention without departing from its teachings as claimed.

What is Claimed is:

1. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider with a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a first center of gravity without the rider and a second center of gravity with the rider in the standard position, and
wherein a distance between a vertical line passing through the first center of gravity and a vertical line passing through the second center of gravity is between 0 cm and 14 cm.

2. The snowmobile of claim 1, wherein the distance is between 2 and 12 cm.

3. The snowmobile of claim 2, wherein the distance is between 4 and 10 cm.

4. The snowmobile of claim 3, wherein the distance is between 5 and 7 cm.

5. The snowmobile of claim 4, wherein the distance is 5 cm.

6. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider with a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a first center of gravity without the rider and a second center of gravity with the rider in the standard position, and
wherein a line passing through the first center of gravity of the snowmobile and the second center of gravity forms an angle with horizontal that is between 35 and 90°.

7. The snowmobile of claim 6, wherein the angle is between 50 and 90°.

8. The snowmobile of claim 7, wherein the angle is between 62 and 90°.

9. The snowmobile of claim 8, wherein the angle is 67°.

10. A snowmobile, comprising:
a frame;
an engine disposed on the frame;
a drive track disposed below the frame and connected operatively to the engine for propulsion of the snowmobile;
a forward-most drive track axle disposed on the frame;
two skis disposed on the frame;
a straddle seat disposed on the frame behind the engine, the seat being dimensioned to support a standard rider with a center of gravity in a standard position in which the standard rider straddles the seat while the snowmobile is heading straight ahead on flat terrain, the standard rider having dimensions and weight of a 50-percentile human male;
a steering device disposed on the frame forward of the seat, the steering device being operatively connected to the two skis for steering the snowmobile; and
wherein a distance between a vertical line passing through the forward-most drive track axle and a vertical line passing through the center of gravity of the rider in the standard position is between 15 and 65 cm.

11. The snowmobile of claim 10, wherein the distance is between 25 and 55 cm.

12. The snowmobile of claim 11, wherein the distance is between 35 and 55 cm.

13. The snowmobile of claim 12, wherein the distance is between 37 and 47 cm.

14. The snowmobile of claim 13, wherein the distance is 40 cm.

15. The snowmobile of claim 14, wherein the distance is 45 cm.

16. A snowmobile, comprising:
a frame;
an engine disposed on the frame;
a drive track disposed below the frame and connected operatively to the engine for propulsion of the snowmobile;
a forward-most drive track axle disposed on the frame;
two skis disposed on the frame;
a straddle seat disposed on the frame behind the engine, the seat being dimensioned to support a standard rider having a center of gravity in a standard position in which the standard rider straddles the seat while the snowmobile is heading straight ahead on flat terrain, the standard rider having dimensions and weight of a 50-percentile human male;
a steering device disposed on the frame forward of the seat, the steering device being operatively connected to the two skis for steering the snowmobile; and
wherein a line passing through the forward-most drive track axle and the center of gravity of the rider in the standard position forms an angle with horizontal that is between 41 and 75°.

17. The snowmobile of claim 16, wherein the angle is between 45 and 65°.

18. The snowmobile of claim 17, wherein the angle is between 50 and 60°.

19. The snowmobile of claim 18, wherein the angle is 55°.

20. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support suitable for a standard rider with a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a center of gravity without the rider, and
wherein a distance between a vertical line passing through the center of gravity of the snowmobile without the rider and a vertical line passing through the center of gravity of the rider in the standard position is between 5 and 55 cm.

21. The snowmobile of claim 20, wherein the distance is between 15 and 45 cm.

22. The snowmobile of claim 21, wherein the distance is between 25 and 45 cm.

23. The snowmobile of claim 22, wherein the distance is between 27 and 37 cm.

24. The snowmobile of claim 23, wherein the distance is 30 cm.

25. The snowmobile of claim 24, wherein the distance is 35 cm.

26. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider having a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a center of gravity without the rider, and
wherein a line passing through the center of gravity of the snowmobile without the rider and the center of gravity of the rider in the standard position forms an angle with horizontal that is between 39 and 79°.

27. The snowmobile of claim 26, wherein the angle is between 49 and 69°.

28. The snowmobile of claim 27, wherein the angle is between 54 and 64°.

29. The snowmobile of claim 28, wherein the angle is 59°.

30. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider with a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a center of gravity with the rider, and
wherein a distance between a vertical line passing through the center of gravity of the snowmobile with the rider and a vertical line passing through the center of gravity of the rider in the standard position is between 0 and 50 cm.

31. The snowmobile of claim 30, wherein the distance is between 10 and 40 cm.

32. The snowmobile of claim 31, wherein the distance is between 20 and 40 cm.

33. The snowmobile of claim 32, wherein the distance is between 22 and 32 cm.

34. The snowmobile of claim 33, wherein the distance is 25 cm.

35. The snowmobile of claim 3434, wherein the distance is 30 cm.

36. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider having a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a center of gravity with the rider, and
wherein a line passing through the center of gravity of the snowmobile with the rider in the standard position and the center of gravity of the rider in the standard position forms an angle with horizontal that is between 35 and 84°.

37. The snowmobile of claim 36, wherein the angle is between 45 and 75°.

38. The snowmobile of claim 37, wherein the angle is between 55 and 70°.

39. The snowmobile of claim 38, wherein the angle is 57°.

40. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a steering device disposed on the frame and spaced forward of the seat such that, when the rider grasps the steering device in the standard position, the rider's torso is tilted toward the steering device and the rider's arms extend toward the steering device with the rider's elbows substantially over the rider's feet;
two skis disposed on the frame and operatively connected to the steering device for steering the snowmobile; and
a footrest disposed below each side of the seat, each said footrest being dimensioned with respect to the seat and the steering device to support the rider's foot thereon,
wherein, for the standard rider in the standard position, the seat defines a seat position, the steering device defines a steering position, and the footrests define a footrest position,
wherein a line passing through the seat position and the steering position forms angle α with a line passing through the seat position and the footrest position;
wherein a line passing through the footrest position and the steering position forms angle β with the line passing through the footrest position and the seat position,
wherein the line passing through the footrest position and the steering position forms angle γ with the line passing through the steering position and the seat position, and
wherein angle α is between 63 and 152°, angle β is between 16 and 84°, and angle γ is between 11 and 42°.

41. The snowmobile of claim 40, wherein angle α is between 67 and 112°, angle β is between 41 and 72°, and angle γ is between 22 and 45°.

42. The snowmobile of claim 41, wherein angle α is between 75 and 97°, angle β is between 52 and 67°, and angle γ is between 30 and 41°.

43. The snowmobile of claim 42, wherein angle α is 83°, angle β is 64°, and angle γ is 33°.

44. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a steering device disposed on the frame and spaced forward of the seat such that, when the rider grasps the steering device in the standard position, the rider's torso is tilted toward the steering device and the rider's arms extend toward the steering device with the rider's elbows substantially over the rider's feet;
two skis disposed on the frame and operatively connected to the steering device for steering the snowmobile; and
a footrest disposed below each side of the seat, each said footrest being dimensioned and configured with respect to the seat and the steering device to support the rider's foot thereon;
wherein, for the standard rider in the standard position, the seat defines a seat position, the steering device defines a steering position, and the footrests define a footrest position,
wherein a line passing through the seat position and the steering position forms angle α with a line passing through the seat position and the footrest position;
wherein a line passing through the footrest position and the steering position forms angle β with the line passing through the footrest position and the seat position,
wherein the line passing through the footrest position and the steering position forms angle γ with the line passing through the steering position and the seat position,
wherein angle α, angle β, and angle γ satisfy the relationship α≥β≥γ; and
wherein a distance between vertical lines passing through the steering position and the seat position is between 40-90 cm.

45. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a steering device disposed on the frame and spaced forward of the seat such that, when the rider grasps the steering device in the standard position, the rider's torso is tilted toward the steering device and the rider's arms extend toward the steering device with the rider's elbows substantially over the rider's feet;
two skis disposed on the frame and operatively connected to the steering device for steering the snowmobile; and
a footrest disposed below each side of the seat, each said footrest being dimensioned and configured with respect to the seat and the steering device to support the rider's foot thereon;
wherein, for the standard rider in the standard position, the seat defines a seat position, the steering device defines a steering position, and the footrests define a footrest position,
wherein a line passing through the seat position and the steering position forms angle α with a line passing through the seat position and the footrest position;
wherein a line passing through the footrest position and the steering position forms angle γ with the line passing through the steering position and the seat position, and
wherein α≈ 2.5γ.

46. A snowmobile, comprising:
a frame;
a straddle seat disposed on the frame, the seat being dimensioned to support a standard rider in a standard position in which the standard rider straddles the seat and the rider's thighs are substantially parallel to ground while the snowmobile is heading straight ahead on flat terrain, the standard rider having dimensions and weight of a 50-percentile human male;
an engine disposed on the frame in front of the seat;
a steering device disposed on the frame and spaced forward of the seat such that, when the rider grasps the steering device in the standard position, the standard rider's torso is tilted toward the steering device and the rider's arms extend toward the steering device with the rider's elbows substantially over the rider's feet; and
two skis disposed on the frame and operatively connected to the steering device for steering the snowmobile;
wherein the seat defines a seat position and the steering device defines a steering position for the standard rider in the standard position, and
wherein a line passing through the steering position and the seat position forms an angle φ with horizontal that is between 15 and 51°.

47. The snowmobile of claim 46, wherein angle φ is between 19 and 41°.

48. The snowmobile of claim 47, wherein angle φ is between 23 and 31°.

49. The snowmobile of claim 48, wherein angle φ is 26°.

50. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a steering device disposed forward of the seat;
two skis disposed on the frame and operatively connected to the steering shaft for steering the snowmobile; and
a windshield disposed forward of the steering device, the windshield having a top;
wherein the seat defines a seat position and the steering device defines a steering position for the standard rider in the standard position, and
wherein a line between the steering position and the seat position forms an angle μ with a line between the seat position and the top of the windshield that lies between 10^{o} and 20°.

51. The snowmobile of claim 50, wherein angle μ is 18°.

52. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a steering device disposed forward of the seat;
two skis disposed on the frame and operatively connected to the steering device for steering the snowmobile; and
a windshield disposed forward of the seat, the windshield having a top;
wherein, when in motion, the windshield defines a laminar flow region of moving air that extends upwardly and rearwardly from the top thereof, and
wherein, when seated in the seat and when grasping the steering device in the standard position, the rider's head is positioned within the laminar flow region.

53. A snowmobile, comprising:
a frame including a pair of footrests;
a straddle seat disposed on the frame;
an engine disposed on the frame in front of the seat;
two skis disposed on the frame;
a forward-most drive track axle disposed on the frame forward of the pair of footrests; and
a steering device disposed on the frame forward of the forward-most drive track axle, the steering device being operatively connected to the two skis for steering the snowmobile.

54. A snowmobile, comprising:
a frame;
a straddle seat disposed on the frame, the seat being dimensioned to support a standard rider in a standard seat position in which the standard rider straddles the seat while the snowmobile is heading straight ahead on flat terrain, the standard rider having dimensions and weight of a 50-percentile human male;
an engine disposed on the frame in front of the seat;
two skis disposed on the frame; and
a steering device disposed on the frame and forward of the seat defining a steering position for the standard rider in the standard seat position, the steering device being operatively connected to the two skis for steering the snowmobile,
wherein a distance between vertical lines passing through the steering position and the standard seat position is between 40 and 90 cm.

55. The snowmobile of claim 54, wherein the distance is between 50 and 80 cm.

56. The snowmobile of claim 55, wherein the distance is between 60 and 80 cm.

57. The snowmobile of claim 56, wherein the distance is 65 cm.

58. The snowmobile of claim 57, wherein the distance is 70 cm.

59. A snowmobile, comprising:
a frame;
a straddle seat disposed on the frame;
an engine disposed on the frame in front of the seat;
two skis disposed on the frame;
a steering device disposed on the frame and operatively connected to the two skis for steering the snowmobile; and
right and left sideboards extending laterally from the frame below the seat on either side thereof, each of the sideboards having a forward portion suitable for placement of a rider's foot thereon, the forward portion of each sideboard disposed at an angle Δ with horizontal that is 5° to -10°; and
right and left toe-holds disposed respectively above the rider's toes in a vertical plane for allowing the rider to releasably secure himself to the snowmobile.

60. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
a drive track operatively coupled to the engine, the drive track including a belt entrained about at least two axles, including a forward-most axle;
two skis disposed on the frame;
a steering device disposed on the frame forward of the seat and operatively connected to the two skis for steering the snowmobile; and
right and left sideboards extending laterally from the frame below the seat on either side thereof, each of the sideboards having a forward portion suitable for placement of a rider's foot thereon,
wherein, for the standard rider in the standard position, the seat defines a seat position, the steering device defines a steering position forward of the forward-most axle of the drive track, and the forward portions of the sideboards define a footrest position,
wherein a line passing through the seat position and the steering position forms angle α with a line passing through the seat position and the footrest position;
wherein a line passing through the footrest position and the steering position forms angle β with the line passing through the footrest position and the seat position,
wherein the line passing through the footrest position and the steering position forms angle γ with the line passing through the steering position and the seat position, and
wherein angle α is between 63 and 152°, angle β is between 16 and 84°, and angle γ is between 11 and 42°.

61. The snowmobile of claim 60, wherein angle α is between 67 and 112°, angle β is between 41 and 72°, and angle γ is between 22 and 45°.

62. The snowmobile of claim 61, wherein angle α is between 75 and 97°, angle β is between 52 and 67°, and angle γ is between 30 and 41°.

63. The snowmobile of claim 62, wherein angle α is 83°, angle β is 64°, and angle γ is 33°.

64. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
two skis disposed on the frame;
a steering device operatively connected to the two skis, the steering device being spaced forward of the seat such that, when the rider grasps the steering device in the standard position, the standard rider's torso is tilted toward the steering device and the rider's arms extend toward the steering device with the rider's elbows substantially over the rider's feet; and
a sideboard extending laterally from the frame below each side of the seat, each said sideboard having a forward portion dimensional and configured with respect to the seat and the steering device to support a rider's foot thereon,
wherein, for the standard rider in the standard position, the seat defines a seat position, the steering device defines a steering position, and the forward portion of each said sideboard defines a footrest position,
wherein a line passing through the seat position and the steering position forms angle α with a line passing through the seat position and the footrest position;
wherein a line passing through the footrest position and the steering position forms angle β with the line passing through the footrest position and the seat position,
wherein the line passing through the footrest position and the steering position forms angle γ with the line passing through the steering position and the seat position, and
wherein angle α, angle β, and angle γ satisfy the relationship α≥β≥γ.

65. A snowmobile, comprising:
a frame;
a straddle seat disposed on the frame, the seat being dimensioned to support a standard rider in a standard position in which the standard rider straddles the seat while the snowmobile is heading straight ahead on flat terrain, the standard rider having dimensions and weight of a 50-percentile human male;
an engine disposed on the frame in front of the seat;
two skis disposed on the frame;
a steering device operatively connected to the two skis, the steering device being spaced forward of the seat such that, when the rider grasps the steering device in the standard position, the standard rider's torso is slightly tilted toward the steering device and the rider's arms extend toward the steering device with the rider's elbows substantially over the rider's feet; and
a sideboard extending laterally from each side of the frame below the seat, each said sideboard having a forward portion dimensioned and configured with respect to the seat and the steering device to support a rider's foot thereon,
wherein, for the standard rider in the standard position, the seat defines a seat position, the steering device defines a steering position, and the forward portions of the sideboards define a footrest position,
wherein a line passing through the seat position and the steering position forms angle α with a line passing through the seat position and the footrest position;
wherein a line passing through the footrest position and the steering position forms angle γ with the line passing through the steering position and the seat position, and
wherein α≥ 2.5γ.

66. The snowmobile of any one of claims 60 to 65further comprising:
right and left toe-holds disposed respectively above the forward portion of each sideboard for allowing the rider to releasably secure himself to the snowmobile.

67. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard load having dimensions and weight of a 50-percentile human male, the load having a center of gravity in a standard position in which the standard load straddles the seat while the snowmobile is on flat terrain;
a footrest positioned on each side of the seat; and
a steering device disposed on the frame forward of the seat, the steering device being operatively connected to the two skis for steering the snowmobile,
wherein the seat, each said footrest and the steering device are positioned and dimensioned with respect to one another so that the snowmobile 1) has a first center of gravity without the standard load and 2) has a second center of gravity when the standard load is in the standard position, and
wherein a distance between a vertical line passing through the first center of gravity and a vertical line passing through the second center of gravity is between 0 cm and 14 cm.

68. A snowmobile having a center of gravity without a rider, comprising:
a frame including a pair of footrests each defining a forward-most surface, the frame including a tunnel defining an upper-most surface;
a straddle seat disposed on the frame;
an engine disposed on the frame in front of the seat;
two skis disposed on the frame; and
a forward-most drive track axle disposed on the frame forward of the pair of footrests and forward of the center of gravity,
wherein an angle between a line passing through the forward-most drive track axle and the center of gravity and a horizontal line passing through the forward-most drive track axle is less than 55°;
wherein the center of gravity is positioned below the upper-most surface of the tunnel, and
wherein the center of gravity is positioned in substantial alignment with the forward-most surface of each of said pair of footrests.

69. A snowmobile, comprising:
a frame;
a straddle seat disposed on the frame;
an engine disposed on the frame in front of the seat;
two skis disposed on the frame;
right and left sideboards extending laterally from the frame below the seat on either side thereof, each of the sideboards having a forward portion disposed at an angle Δ with horizontal that is 5° to -10°; and
right and left toe-holds associated with the right and left sideboards to allow the rider to releasably secure himself to the snowmobile.

70. A snowmobile, comprising:
a frame;
an engine disposed on the frame;
a drive track disposed below the frame and connected operatively to the engine for propulsion of the snowmobile;
two skis disposed on the frame;
a straddle seat disposed on the frame behind the engine, the seat being dimensioned to support a standard rider with a center of gravity in a standard position in which the standard rider straddles the seat while the snowmobile is heading straight ahead on flat terrain, the standard rider having dimensions and weight of a 50-percentile human male; and
a steering device disposed on the frame forward of the seat, the steering device being operatively connected to the two skis for steering the snowmobile,
wherein the snowmobile has a first center of gravity without the rider and wherein the snowmobile is adapted to have a second center of gravity with the rider in the standard position such that, in use, a distance between a vertical line passing through the first center of gravity and a vertical line passing through the second center of gravity is between 0 cm and 14 cm.

71. The snowmobile of claim 40, further comprising a tunnel and an endless drive track housed within the tunnel, the endless drive track being operatively coupled to the engine.

72. A snowmobile, comprising:
a frame;
a straddle seat disposed on the frame;
an engine disposed on the frame in front of the seat;
a steering device disposed on the frame and spaced forward of the seat;
two skis disposed on the frame and operatively connected to the steering device for steering the snowmobile; and
a footrest disposed below each side of the seat;
wherein, for the standard rider in the standard position, the seat defines a seat position, the steering device defines a steering position, and the footrests define a footrest position,
wherein a distance between vertical lines passing through the steering position and the seat position is between 40-90 cm.

73. A snowmobile, comprising:
a frame having a forward-most drive track axle disposed thereon;
a straddle seat disposed on the frame;
an engine disposed on the frame in front of the seat;
two skis disposed on the frame; and
a steering device disposed on the frame and operatively connected to the two skis for steering the snowmobile;
wherein the snowmobile has a center of gravity without a rider and the steering device is disposed on the frame forward of the center of gravity, and wherein the forward-most axle is positioned forward of the center of gravity and rearward of a rearward-most portion of the steering device such that the center of gravity is rearward of the rearward-most portion of the steering device,
wherein the frame includes a tunnel, and the forward-most drive track axle is positioned on the tunnel.

74. An assembly comprising:
a frame including a tunnel;
a straddle seat mounted on the frame;
an engine disposed on the frame in front of the seat;
two skis disposed on the frame;
a steering shaft operatively connected to the two skis, the steering shaft being disposed over the engine at an angle εof between 25° and 40° from vertical;
wherein the tunnel supports a drive belt coupled to the engine and defines a footrest on each side of the seat that is inclined at an angle Δ with horizontal that is between 0° to -10°; and
wherein a forward-most axle of the drive belt is positioned rearward of the steering shaft.
